(19) United States
(12) Patent Application Publication
(10) Pub. No.: US 2005/0127279 A1
(43) Pub. Date: Jun. 16, 2005

(54) Multiplexed fiber optic sensor system

(76) Inventor: Martin R. Harris, Windsor (AU)

Correspondence Address: STITES & HARBISON PLLC, 1199 NORTH FAIRFAX STREET, SUITE 900, ALEXANDRIA, VA, 22314, US

(21) Appl. No.: 10/917,513

(22) Filed: Aug. 13, 2004

(30) Foreign Application Priority Data
Aug. 15, 2003 (AU) 2003904412

(51) Int. Cl. G01N 21/00

(52) U.S. Cl. 250/227.26; 356/73.1; 250/458.1

(57) ABSTRACT

A multiplexed fiber optic sensor system. The system has an array of sensor elements, each responsive to a respective measurand, a light source, a fiber optic waveguide for directing light from the source to the array, a scanner for providing relative motion between the array and the light, a beamsplitter for receiving return light from the array so that the return light can be detected for analysis, and a photodetector for receiving the return light and providing an output signal in response thereto. The scanner is operable to scan the light over the sensor elements so that return light be collected from each respective element, whereby data can be determined concerning each respective measurand.

### RELATED APPLICATION

This application is based on and claims the benefit of the filing date of Australian patent application no. 2003904412 filed 15 Aug. 2003, the contents of which are incorporated herein by reference in its entirety.

### FIELD OF THE INVENTION

The present invention relates to a multiplexed fiber optic sensor system of particular but by no means exclusive application in monitoring gases, micro-organisms and other substances for concentration, temperature and humidity.

### BACKGROUND OF THE INVENTION

Fiber optic sensor systems and optrodes have been developed intensively for over a quarter of a century. By the mid 1980s, the designs of most of the existing fiber optic sensors had been proposed and tested (see, for example, Dakin and Culshaw, Optic Fibre Sensors, IV: Analysis and Future Trends).

In the following description, reference is made to “measurands” and to “optrodes”. A measurand is a parameter that is desired to be measured, such as temperature, humidity, oxygen, partial pressure or carbon monoxide concentration. An optrode is an optical arrangement connected to the tip of an optic fiber to allow optical determination of a measurand (cf. electrode).

Although it is possible to devise an optic fiber/optrode system for any single desired measurand, the cost is generally much greater than for existing non-fiber based systems. Indeed, the cost may be 10 to 1,000 times greater owing to:
1. Development cost amortization;
2. Cost of fabrication of fiber link, connectorisation, etc;
3. Cost of light source, detector, optics and reference electronics; and
4. The complexity of providing an optical reference.

This price disadvantage has inhibited the wide use of fiber optic sensor systems. However, fiber optic measurement systems have been successfully commercialized where:
1. The unique advantages (e.g. electrical isolation) justify the expense of a single point optical detector, such as in the form of a temperature sensor based on fluorescence delay time (used in industrial microwave ovens);
2. Where one set of optics and electronics is able to interrogate and quantify the measurand at a very large number of points along a fiber, by means of optical time domain reflectometry (for example in a distributed temperature sensor in which the fiber temperature can be measured at intervals of, say, 50 cm over a length of several hundred metres); and
3. Systems in which the whole length of the fiber acts as the sensor, such as for embedded strain measurement in concrete, for perimeter vibration detectors and for liquid petroleum gas spill alarm systems.

### SUMMARY OF THE INVENTION

The present invention provides, therefore, a multiplexed fiber optic sensor system, comprising:
an array of sensor elements, each responsive to a respective measurand;
a light source;
a fiber optic waveguide for directing light from sail source to said array:
a scanner for providing relative motion between said array and said light;
a beamsplitter for receiving return light from said array so that said return light can be detected for analysis; and
a photodetector for receiving said return light and providing an output signal in response thereto;
wherein said scanner is operable to scan said light over said sensor elements so that return light be collected from each respective element, whereby data can be determined concerning each respective measurand.

The waveguide preferably comprises a single fiber or a fiber bundle.

The return light is preferably either reflected light, fluorescent light or both reflected and fluorescent light.

Thus, the invention provides a system in which, for example, a fiber or a bundle of fibers can be used to measure the signal from a number of closely spaced measuring points. The scanner can comprise, for example, any of the miniaturized scanning devices developed by Optiscan Pty Ltd, can be installed remotely from the photodetector and can readily be adapted to perform the scan over an array of elements at closely spaced measuring points.

One application of such a system is as an optic time domain reflectometer system used to monitor the temperature of a multiplicity of points in a single fiber, woven between bricks in the outer layer of large furnaces.

The system would have some important advantages, for example by providing an auto-referencing signal with compensation for factors such as photo bleaching or environmental degradation of the optical material. It would permits novel areas of fiber optic sensing in which small changes in the position of objects in the sensor visual field are used to give information on the measurand.

The invention could operate with multimode fibers or single mode fibers, and can could use blue LEDs and potentially any scan mechanism including tuning fork or mirror scanning mechanisms. It could also be configured to scan without a lens set separate from the optical fiber depending on the actual dimensions of the sensor array. In other words, a single tightly focused diffraction limited spot scan may not be required.

It is envisaged that in some embodiments, it would be possible for one fiber to interrogate and give numerical readouts on the fluorescence or reflection of up to a million separate sensor points in just over one second.

Much of the work on the detection of chemicals using optic fiber sensors has been directed to the development and testing of optrode materials for military objectives (e.g. at the US Naval Research Laboratories). The detection of airborne and waterborne toxic agents and bacteria are areas in which it is anticipated that this claimed invention could be applied. These are of particular relevance at the present time and as potential applications of the present invention.

The light source is preferably a laser source or an LED, and may be monochromatic, have a spectrum comprising two or more wavelengths, or comprise a broad band spectrum.

In one embodiment, said light source comprises a plurality of separate light sources, and the system includes means for combining light from each of said sources into a single beam of light. Preferably each of said plurality of light sources has an output of different wavelength (or different color), and more preferably each comprises an LED.

In one embodiment, the light comprises at least two wavelengths so that data can be calibrated on the basis of a comparison of the response of each of said sensor elements to the respective wavelength components of said light.

The system may include a fiber optic waveguide for collecting return light from said array. This may be a further waveguide, or a single fiber optic waveguide can be used to transmit both the incident light and the return light. In either case, the fiber optic waveguide or waveguides may each comprise a single fiber or a fiber bundle.

The array may additionally include at least one reference sensor element of known characteristics so that data from at least one other of said sensor elements can be normalized or calibrated against said reference sensor element.

Thus, compensation can be applied to measurements for the undesired effects of, for example, photo bleaching of optrode material, spontaneous degradation, and optical losses in the system (including due to bending of fibers, etc). The reference element is preferably insensitive to changes in the measurand of the sensor element for which it acts as a reference.

In one embodiment, the array additionally includes a plurality of reference sensor elements, one for each respective sensor element sensitive to a respective measurand.

Thus, for each measurand there would be, in this embodiment, a corresponding reference sensor element.

The present invention also provides a method of performing multiplexed fiber optic sensing, comprising:

transmitting light by means of a fiber optic waveguide to an array of sensor elements, each responsive to a respective measurand;

scanning said light over said array;

collecting and detecting return light from said array and generating a signal indicative thereof;

whereby data can be determined concerning each respective measurand.

It will be appreciated that the method may include steps corresponding to the various functions provided by the optional features of the above-described system.

### BRIEF DESCRIPTION OF THE FIGURES

In order that the invention may be more clearly ascertained, preferred embodiments will now be described, by way of example, with reference to the accompanying drawings, in which:

FIG. 1 is a schematic view of a multiplexed fiber optic sensor system according to one embodiment of the present invention;

FIG. 2 is a schematic view of a multiplexed fiber optic sensor system according to another embodiment of the present invention;

FIG. 3A is a detail of the systems shown in FIGS. 1 and 2;

FIG. 3B is a detail of a variation of the systems shown in FIGS. 1 and 2 in which scanning is effected by means of a movable lens;

FIG. 4 is a schematic view of a multiplexed fiber optic sensor system according to further embodiment of the present invention;

FIG. 5 is a schematic view of a multiplexed fiber optic sensor system according to a still further embodiment of the present invention; and

FIG. 6 is an image obtained by means of the system of FIG. 5.

### DETAILED DESCRIPTION

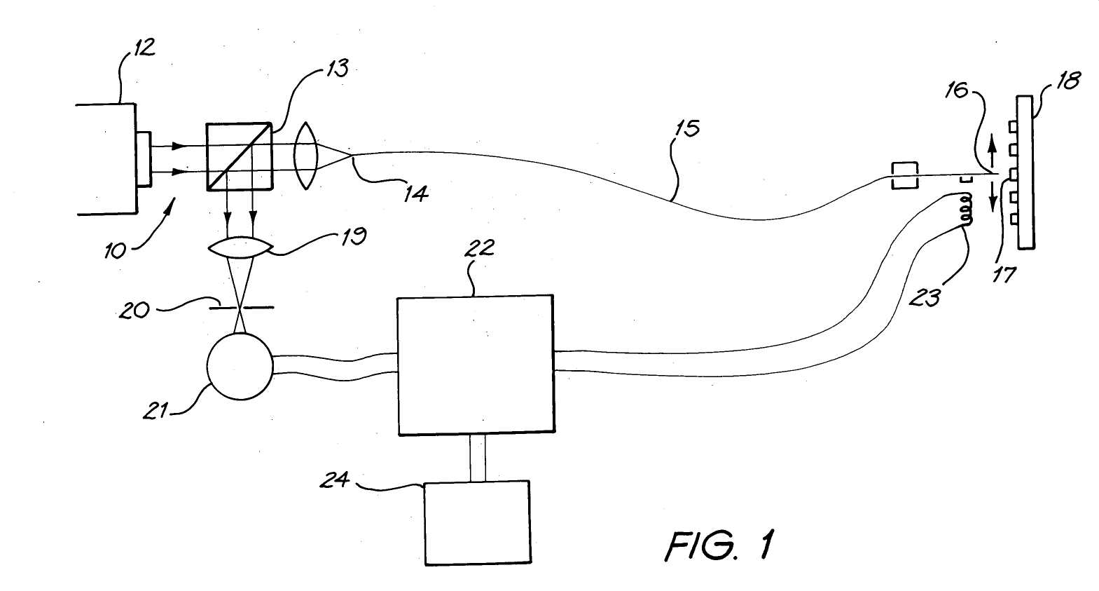

A multiplexed fiber optic sensor system according to one embodiment of the present invention is shown schematically in FIG. 1. A light beam 10 is emitted from a light source 12, passes through a beamsplitter 13 and is then focussed by a lens into the core at the proximal or entry tip 14 of an optic fiber 15. The light energy passes along the fiber and emerges from the distal or exit tip 16 of the fiber 15 where it is directed to impinge upon a single sensor element 17, which is in close proximity to the fiber exit tip 16.

Sensor element 17 is one of a plurality of sensor elements constituting a sensor array 18. Notably, no objective is employed: the fiber tip 16 is simply located sufficiently close to array 18. It is envisaged that the separation would be from a few microns to 10 or 20 microns, but this should be adjusted—as will be appreciated by those skilled in the art—according to light source, etc. The array 18 additionally includes reference elements, one for sensor element and in each located adjacent to its corresponding sensor element. These reference elements are selected to be insensitive to the measurand of the corresponding sensor element, so that the data from the sensor element can be corrected or normalized for the undesired effects of, for example, photo bleaching of optrode material, spontaneous degradation, and optical losses in the system (including due to bending of fibers, etc). The system can therefore be described as “self-referencing” or “self-normalizing”.

The array 18 can be any desired shape, and this choice will generally depend on the scanning technique employed. If scanning is effected by means of a tuning fork in one (fast) direction and a slower scan in the other direction, a rectangular array 18 may be appropriate. However, if scanning is effected in a manner that produced circular fiber or array motion, a circular array 18 may be preferred.

Some light from the sensor element 17 (which may be reflected light, fluorescence, etc., emitted in response to the incident light energy) is coupled back through the fiber tip 16 as return light, and hence along fiber 15 to re-emerge from proximal fiber tip 14. This return light is directed by beamsplitter 13 to a lens 19, which focusses the return light to pass through a spatial filter 20. The return light then impinges upon photo transducer 21. The electrical signal output by transducer 21 is passed to the central, control electronics 22, which is also connected to an actuator 23 that moves the fiber exit tip 16 to optically couple that tip to each of the sensor elements sequentially.

A synchronization signal allows the output from the phototransducer 21 to be correlated with the instant sensor element of array 18 being observed. This allows a quantification of each parameter to be obtained and displayed on display 24. It is preferred that the scanning motion of exit tip 16 should be resonant to reduce energy requirements. Additional scanning in an orthogonal direction or directions (whether x-y, x-z or x-y-z scanning) is also possible. This would increase the number of sensor spots that can be scanned and thereby interrogated. It is anticipated that each sensor array 18 could be produced using gene chip production techniques.

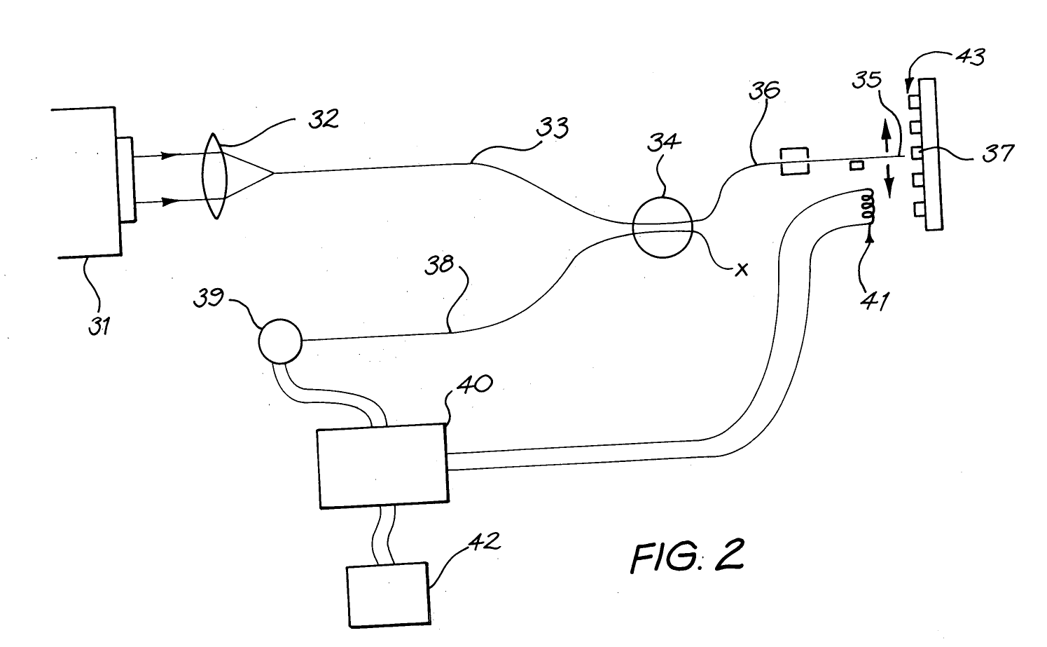

A multiplexed fiber optic sensor system according to another embodiment of the present invention is shown schematically in FIG. 2. The system of FIG. 2 employs a fused biconical taper coupler or other in-fiber beamsplitter device as the beamsplitter to direct the return signal light to the photodetector.

Referring to FIG. 2, light from light source 31 is focussed by lens 32 into a fiber 33. The light travels along the core of fiber 33 until it reaches a fiber coupler 34 and from the coupler to the exit tip 35 of coupler leg 36. Return light returning from a particular sensor element 37 in close proximity to the fiber exit tip 35 travels to the coupler 34, and a portion of the light is conveyed along coupler leg 38 to a photodetector 39. The control electronics 40, fiber scanning mechanism 41 and display 42 are the same as the corresponding elements of the embodiment shown in FIG. 1.

The scanning interrogation of the sensor array 43 can be achieved by moving the fiber tip 35 as described above, or alternatively by moving (preferably resonantly) the sensor array 43 itself. It may be desirable that the motion of the array 43 be arranged so that it produces a flow of a gas being monitored over the sensor elements 37. This would speed up the reaction time by creating turbulence.

Alternatively, a fan can be used to force the monitored gas over the array 43 and thereby speed up the reaction time.

It is possible, and indeed desirable in some embodiments, that a lens be interposed between the fiber exit tip 35 and the array 43 of sensor elements 37, in order to converge the optical energy emanating from the fiber tip 35 to focus into or onto each individual sensor element 37 in turn. The optical energy returned by each sensor element 37 is re-converged into the fiber tip 35, where it is coupled as bound energy modes and travels back to the photodetector 39.

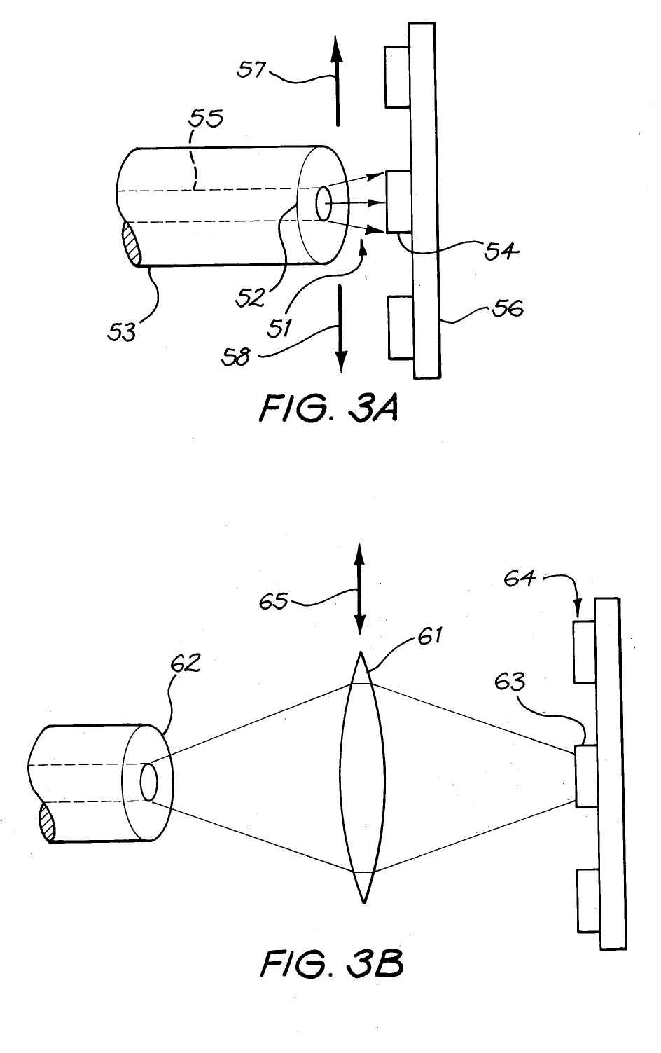

In embodiments where a lens is used in this manner, the scanning of the spot of light across the array 43 of sensor elements 37 can also be achieved by motion of that lens itself. Where such a lens is not used (see FIG. 3A), light 51 emerges from the tip 52 of the optic fiber 53 and impinges on sensor element 54. Reflected light or fluorescence from the sensor element 54 returns into the cora 55 of fiber 53 and is carried back to the beamsplitter (such as beamsplitter 13 of FIG. 1 or fiber coupler 34 of FIG. 2). Scanning is achieved by moving the fiber tip 55 or by moving the sensor array 56 (or both) to achieve relative motion in the directions indicated by arrows 57 and 58.

In embodiments where a lens is in fact used in this manner (see FIG. 3B), a lens 61 may be located between the fiber exit tip 62 and the instant sensor element 63. This converts the system from a near field-scanning mode to a confocal mode of operation. In this case the scanning of the array 64 of sensor elements 63 may be carried out by movement of the lens 61 in the direction indicated by arrow 65.

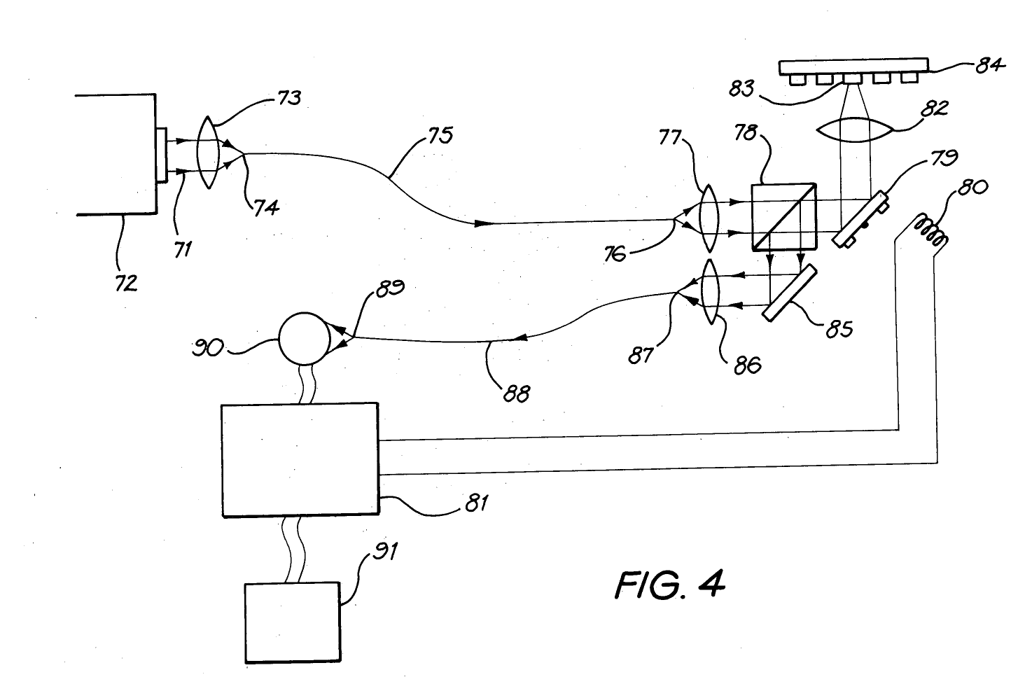

Scanning can also be carried out by means of a movable mirror. A multiplexed fiber optic sensor system in which a scanning mirror is used, according to a further embodiment of the present invention, is shown schematically in FIG. 4. This embodiment also uses a bulk optic beamsplitter at the distal (sensor head) end. This totally separates the outgoing and returning optical energy paths in the fibers(s).

Thus, referring to FIG. 4, a light beam 71 from light source 72 is focussed by a lens 73 into the proximal tip 74 of an optic fiber 75. The light travels along the fiber 75 to the distal or exit tip 76. The optical energy emerges from the fiber tip 76, is collimated by a lens 77 and passes through a beamsplitter 78. It then is reflected by a scanning mirror 79. The mirror 79 is connected to an actuator 80 that is controlled by control electronics 81 to move the mirror 79.

After reflection from the scanning mirror 79, the beam is focussed by a further lens 82 onto an individual sensor element 83 in an array 84 of sensor elements. Return light re-emanated from the sensor element 83 returns via lens 82 and scanning mirror 79 to beamsplitter 78. A portion of the return light is diverted from its path by the beamsplitter 78 to mirror 85, and reflected to lens 86 which focuses the return light into the core at the tip 87 of an optic fiber 88. The light is transmitted by fiber 88 to its other end 89 from which it emerges to impinge on the phototransducer 90. The output signal of the phototransducer 90 is transmitted to the control electronics 81, where it is processed using the actuator feedback signal from actuator 80 to correlate the position of the scanning mirror 79 and hence identity of sensor element 83 with the data being received from the phototransducer 90, to provide a read-out of the parameters that are being measured. This read out is displayed on display 91.

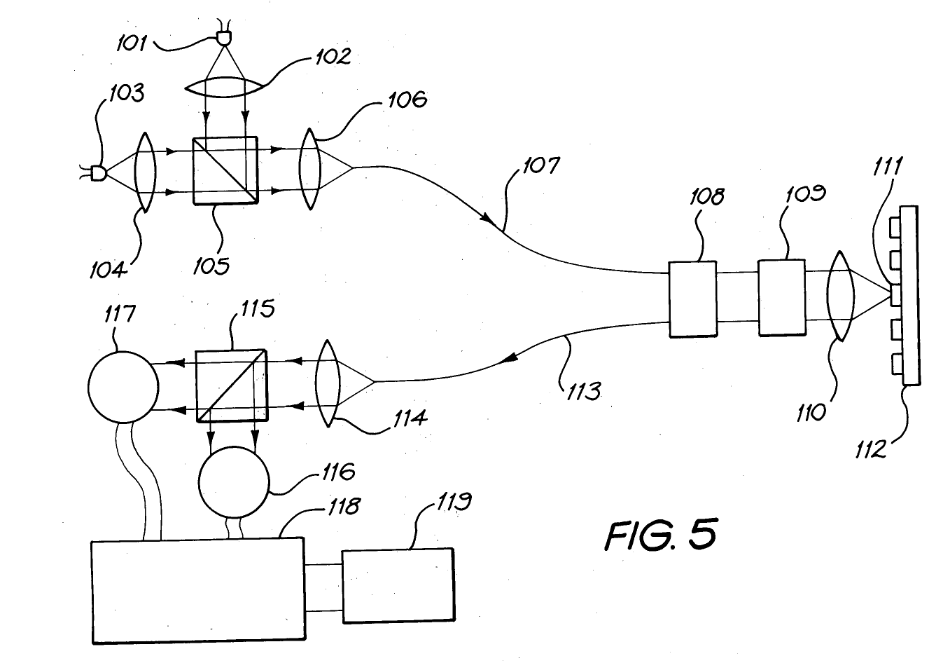

In some existing sensor systems, the measurement is made using a change in color of the optrode material using reflected light. The embodiments described herein of the present invention preferably use monochromatic light to provide a reference reflection from an adjacent spot on the sensor array (constituting a reference sensor element) to compensate for fiber transmission variations. It is also possible to use the ratio of two wavelength or color spectral regions (as shown in FIG. 5). A white light source or two separate colored sources (such as LEDs) could be used for this purpose.

Thus, a multiplexed fiber optic sensor system according to a still further embodiment of the present invention is shown schematically in FIG. 5. Optical energy from a first light source in the form of first LED 101 is collimated by means of a first lens 102 and combined with light from second light source in the form of second LED 103 that has been collimated by a second lens 104. LEDs 101 and 103 have light outputs of different wavelengths.

The light is combined by means of a dichroic beamsplitter 105 which directs the combined light to focussing lens 106. Lens 106 focusses the light into optic fiber 107, and transmits the light to a wavelength independent beamsplitter 108. The light is scanned by scanner 109 (which can be of any suitable form) and focussed by lens 110 onto the sensor element 111 of array sensor 112 in turn.

Fiber 107 is multimode, which allows the transmission of the two wavelengths and, as the fiber 107 therefore has a greater core diameter, also increases the intensity of light that can be transmitted. This makes this embodiment particular suitable for reflection systems.

The return light is separated by the beamsplitter 108 and transmitted by means of a further optic fiber 113 (whose output is collimated by lens 114) to a dichroic beamsplitter 115, to which splits the two wavelength components and diverts them to respective photomultipliers 116 and 117. The output signals of photomultipliers 116 and 117 are inputted into control electronics 118. The ratio of the signals from photomultipliers 116, 117 provides a value for the measurand at each of the sensor spots. The results are then displayed on display 119

### EXAMPLE

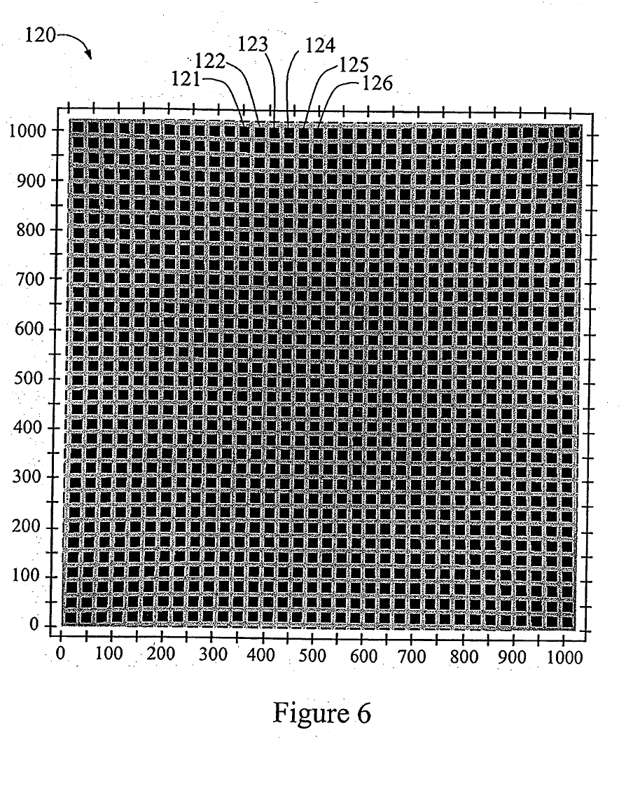

FIG. 6 is an image taken with the system shown in FIG. 5. The image is of an electron microscope grid 120; such a grid could be used as a holder of optrode sensor material and hence act as the substrate of a sensor array.

The vertical and horizontal units in FIG. 6 are arbitrary.

In this instance the image was taken with synchronized acquisition electronics using blue 488 nm light from an Argon ion laser as illumination and using the longer wavelength fluorescence to acquire the image.

When in use as a sensor array substrate, some of the interstices 121, 122 and 123 in the grid 120 would be filled with materials that change fluorescence intensity or color when exposed to the gases that are desired to be measured. Interstice 124 would be filled with a material that does not change fluorescence intensity or wavelength when exposed to these gases, while interstice 125 would be filled with a fluorescent substance that changes fluorescence with temperature. Interstice 126 would be filled with a substance that changes fluorescence with humidity.

The output intensity of the fluorescence from interstice 124 would be used to normalize the outputs from the materials at interstices 121, 122 and 123 (i.e. the intensity of the return fluorescence from interstice 124 is used to compensate for optical losses in the system). The signals from the materials at interstices 125 and 126 would used to compensate for temperature and humidity dependence of the (fluorescent) sensor materials at interstices 121, 122 and 123. Cross sensitivities between the gases could also be compensated for.

The use of multimode optical fiber results in a concomitant trade-off in that a larger core will need correspondingly larger sensor spots and the dimensions of the sensor head would need to be increased, or alternatively only a smaller number of spots would be monitored.

For example if a Pentax brand insert is used as the basis of this system using single mode fiber, core diameter 3 microns, it is expected that it would be feasible to monitor up to 10,000 sensor elements. If multimode fiber is used and the core size is 30 microns (capturing 100 times the light from an incoherent source) then the number of sensor elements that could be interrogated would be reduced by a factor of 100.

There would be some advantage in having the scanning carried out by means of pneumatic mechanism. This could be a simple vibrating reed type design carrying the optic fiber. A vacuum tube line to the head could also simultaneously increase the airflow over the sensor elements, which would increase the response time. If such a system was implemented it would be to possible generate the synchronization signal from the waveform of the optical return signal as in phase locked loop systems.

In conclusion, it is envisaged that the present invention can be used to provide the following advantages over existing systems:
1. One sensor head can measure a great number of parameters simultaneously;
2. Several measurements can be combined to eliminate interferences between different parameters;
3. Reference elements can be included in the sensor array to allow compensation for effects such as photo bleaching of optrode material, spontaneous degradation, optical losses in the system (including due to bending of fibers, etc);
4. One sensor design can be used for a great variety of applications by changing the sensor spot array plate;
5. The sensor spot array plate can be made by standard gene chip techniques;
6. Can be made with low cost light sources using MM fiber.
7. The technique cancels out most variation problems, and allows various unique designs to be implemented where motion of a sensor element or object is to be quantified, such as temperature via a bimetal element, humidity where swelling of a humectant can be monitored, refractive index, and motion of a structure.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

1. A multiplexed fiber optic sensor system, comprising:
an array of sensor elements, each responsive to a respective measurand;
a light source;
a fiber optic waveguide for directing light from said source to said array;
a scanner for providing relative motion between said array and said light;
a beamsplitter for receiving return light from said array so that said return light can be detected for analysis; and
a photodetector for receiving said return light and providing an output signal in response thereto;
wherein said scanner is operable to scan said light over said sensor elements so that return light be collected from each respective element, whereby data can be determined concerning each respective measurand.

2. A sensor system as claimed in claim 1, wherein the waveguide comprises a single fiber or a fiber bundle.

3. A sensor system as claimed in claim 2, wherein the waveguide comprises one or more multimode fibers or single mode fibers.

4. A sensor system as claimed in claim 1, wherein the return light comprises either reflected light, fluorescent light or both reflected and fluorescent light.

5. A sensor system as claimed in claim 1, wherein the light source comprises a laser source or an LED.

6. A sensor system as claimed in claim 1, wherein the light source is monochromatic.

7. A sensor system as claimed in claim 1, wherein the light source has a spectrum comprising two or more wavelengths.

8. A sensor system as claimed in claim 1, wherein the light source comprises a broad band spectrum.

9. A sensor system as claimed in claim 1, wherein the light source comprises one or more blue LEDs.

10. A sensor system as claimed in claim 1, wherein the light source comprises a plurality of separate light sources, and the system includes means for combining light from each of said sources into a single beam of light.

11. A sensor system as claimed in claim 10, wherein each of said plurality of light sources has an output of different wavelength.

12. A sensor system as claimed in claim 10, wherein each of said plurality of light sources comprises an LED.

13. A sensor system as claimed in claim 1, wherein the light from said source comprises at least two wavelengths so that data can be calibrated on the basis of a comparison of the response of each of said sensor elements to the respective wavelength components of said light.

14. A sensor system as claimed in claim 1, including a fiber optic waveguide for collecting said return light.

15. A sensor system as claimed in claim 14, wherein the fiber optic waveguide for collecting said return light and the fiber optic waveguide for directing light from said source to said array are provided as a single fiber optic waveguide for transmitting both the incident light and the return light.

16. A sensor system as claimed in claim 1, wherein said array additionally includes at least one reference sensor element of known characteristics so that data from at least one other of said sensor elements can be normalized or calibrated against said reference sensor element.

17. A sensor system as claimed in claim 16, wherein the reference element is substantially insensitive to changes in the measurand of the sensor element for which it acts as a reference.

18. A sensor system as claimed in claim 1, wherein said array additionally includes a plurality of reference sensor elements, one for each respective sensor element sensitive to a respective measurand.

19. An optic time domain reflectometer, comprising a sensor system as claimed in claim 1.

20. A method of performing multiplexed fiber optic sensing, comprising:
transmitting light by means of a fiber optic waveguide to an array of sensor elements, each responsive to a respective measurand;
scanning said light over said array;
collecting and detecting return light from said array and generating a signal indicative thereof;
whereby data can be determined concerning each respective measurand.
